(19) United States
(12) Patent Application Publication
(10) Pub. No.: US 2025/0312717 A1
(43) Pub. Date: Oct. 9, 2025

(54) GAS-LIQUID SEPARATOR

(71) Applicants: HYUNDAI MOTOR COMPANY, SEOUL (KR); KIA CORPORATION, SEOUL (KR)

(72) Inventor: Min Jae KIM, Hwaseong-si (KR)

(21) Appl. No.: 18/957,157

(22) Filed: Nov. 22, 2024

(30) Foreign Application Priority Data
Apr. 8, 2024 (KR) 10-2024-0047550

(51) Int. Cl. B01D 45/16; B01D 45/08

(52) U.S. Cl. CPC B01D 45/16; B01D 45/08

(57) ABSTRACT

The present disclosure relates to a gas-liquid separator including a housing member having an inlet port through which air is introduced, and a discharge port through which the air is discharged. A vortex generation member is provided in the housing member and is configured to generate a vortex in the air introduced into the housing member so that droplets contained in the air come into contact with an inner surface of the housing member. A variable pressure flow path is provided in the housing member as well, and is configured to guide the flow of air, from which the droplets are separated, to the discharge port and change pressure of the air from an inlet toward an outlet thereof, thereby obtaining an advantageous effect of ensuring efficiency in capturing droplets and minimizing an increase in differential pressure.

### CROSS-REFERENCE TO RELATED APPLICATION

This application claims priority to and the benefit of Korean Patent Application No. 10-2024-0047550 filed in the Korean Intellectual Property Office on Apr. 8, 2024, the entire contents of which are incorporated herein by reference.

### TECHNICAL FIELD

The present disclosure relates to a gas-liquid separator, and more particularly, to a gas-liquid separator capable of minimizing an increase in differential pressure while ensuring performance in capturing droplets.

### BACKGROUND

A fuel cell vehicle (e.g., a hydrogen fuel cell vehicle) is configured to autonomously generate electricity by means of a chemical reaction between fuel (hydrogen) and air (oxygen) and travel by operating a motor.

The fuel cell vehicle generally may include a fuel cell stack configured to generate electricity by means of an oxidation-reduction reaction between hydrogen and oxygen, a fuel supply device configured to supply fuel (hydrogen) to the fuel cell stack, an air supply device configured to supply the fuel cell stack with air (oxygen) which is an oxidant required for an electrochemical reaction, and a thermal management system (TMS) configured to discharge heat, which is generated from the fuel cell stack and power electronic parts of the vehicle, to the outside of the system and control temperatures of the fuel cell stack and the power electronic parts.

Further, discharge water (condensate water) and exhaust gas (e.g., air), which are produced during the operation of the fuel cell stack, may be discharged to the outside through an exhaust pipe.

Meanwhile, droplets may be contained in the air discharged during the operation of the fuel cell stack. In case that the air containing droplets is discharged to surrounding pedestrians or peripheral devices, the air containing droplets may cause unpleasantness to the surrounding pedestrians or corrosion of the peripheral devices.

In addition, in case the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

Various types of studies have been conducted to effectively remove the droplets from the air discharged during the operation of the fuel cell stack, but the study results remain insufficient.

### SUMMARY

The present disclosure has been made in an effort to provide a gas-liquid separator capable of minimizing an increase in differential pressure while ensuring performance in capturing droplets contained in air discharged from a fuel cell stack.

The present disclosure has also been made in an effort to minimize a deterioration in energy efficiency caused by an increase in differential pressure of the gas-liquid separator while miniaturizing the gas-liquid separator.

Among other things, the present disclosure has been made in an effort to change pressure by allowing air, from which droplets are separated by a vortex, to move along a variable pressure flow path.

The present disclosure has also been made in an effort to simplify a structure and improve a degree of design freedom and spatial utilization.

The present disclosure has also been made in an effort to minimize a degree to which droplets and air are mixed again and improve efficiency in separating (capturing) droplets.

The objects to be achieved by the embodiments are not limited to the above-mentioned objects, but also include objects or effects that may be understood from the solutions or embodiments described below.

In order to achieve the above-mentioned objects, an exemplary embodiment of the present disclosure provides a gas-liquid separator including a housing member having an inlet port through which air is introduced, and a discharge port through which the air is discharged, a vortex generation member provided in the housing member and configured to generate a vortex in the air introduced into the housing member so that droplets contained in the air come into contact with an inner surface of the housing member, and a variable pressure flow path provided in the housing member and configured to guide the air, from which the droplets are separated, to the discharge port and change pressure of the air from an inlet toward an outlet thereof.

This is to effectively capture droplets contained in air discharged from a fuel cell stack.

That is, droplets may be contained in the air discharged during the operation of the fuel cell stack. In case that the air containing droplets is discharged to surrounding pedestrians or peripheral devices, the air containing droplets may cause unpleasantness to the surrounding pedestrians or corrosion of the peripheral devices. In addition, in case that the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

In contrast, according to an embodiment of the present disclosure, the air containing droplets is discharged through the vortex generation member and the variable pressure flow path. Therefore, it is possible to obtain an advantageous effect of ensuring the performance in capturing droplets contained in the air and minimizing an increase in differential pressure. Moreover, it is possible to minimize the number of droplets contained in the air discharged from the fuel cell stack. Therefore, it is possible to obtain an advantageous effect of inhibiting contamination caused by the droplets and reducing risks of the occurrence of accidents (e.g., a slip-and-fall accident, an electric shock accident, etc.).

Among other things, according to an embodiment of the present disclosure, the pressure of the air is changed (e.g., increased) as the air, from which droplets are separated by the vortex, moves along the variable pressure flow path. Therefore, it is possible to obtain an advantageous effect of minimizing an increase in differential pressure while miniaturizing the gas-liquid separator.

According to the exemplary embodiment of the present disclosure, the inlet port may be provided at one end of the housing member based on the longitudinal direction of the housing member. The inlet port may be provided in a main wall portion (sidewall portion) of the housing member.

According to the exemplary embodiment of the present disclosure, a center of the inlet port may be defined to be inclined at a third reference angle preset with respect to a second reference line that passes through a center of the discharge port in the longitudinal direction of the housing member.

The third reference angle may be variously changed in accordance with required conditions and design specifications. According to the exemplary embodiment of the present disclosure, the third reference angle may be defined to be 60 to 120 degrees.

As described above, in an embodiment of the present disclosure, the center of the inlet port is disposed to be inclined at 60 to 120 degrees with respect to the second reference line. Therefore, it is possible to obtain an advantageous effect of stably ensuring the efficiency in generating a vortex in the air in the housing member.

The vortex generation member may have various structures capable of generating a vortex in the air introduced into the housing member.

According to the exemplary embodiment of the present disclosure, the vortex generation member may be provided in the housing member and spaced apart from an inner peripheral surface of the housing member.

According to the exemplary embodiment of the present disclosure, one end of the vortex generation member may be connected to the housing member and communicate with the discharge port, and the other end of the vortex generation member may be disposed as a free end spaced apart from the inner surface of the housing member.

The variable pressure flow path may have various structures capable of gradually changing the pressure of the air from the inlet toward the outlet.

According to the exemplary embodiment of the present disclosure, the variable pressure flow path may be configured to gradually increase the pressure of the air from the inlet toward the outlet thereof.

According to the exemplary embodiment of the present disclosure, the variable pressure flow path may be provided to have a cross-sectional area that gradually increases from the inlet toward the outlet.

According to the exemplary embodiment of the present disclosure, the variable pressure flow path may be defined along the inside of the vortex generation member.

As described above, in an embodiment of the present disclosure, the variable pressure flow path is defined along the inside of the vortex generation member, such that the variable pressure flow path for minimizing an increase in differential pressure by applying a centrifugal force to the air (applying a centrifugal force for generating a vortex) may be defined by means of the single vortex generation member without separately providing a structure for generating a vortex in the air and a structure for defining the variable pressure flow path. Therefore, it is possible to obtain an advantageous effect of further miniaturizing the gas-liquid separator and improving the spatial utilization and the degree of design freedom.

According to an exemplary embodiment of the present disclosure, a main wall portion of the vortex generation member, which defines the variable pressure flow path, may be provided to be inclined at a first reference angle preset with respect to a first reference line that passes through a center of the vortex generation member in a longitudinal direction of the housing member.

As described in the embodiment above, the first reference angle with respect to the first reference line is defined to be larger than 0 degrees and equal to or smaller than 30 degrees. Therefore, it is possible to obtain an advantageous effect of ensuring the performance in changing pressure (performance in reducing differential pressure) by means of the variable pressure flow path and ensuring a sufficient discharge flow rate of the air.

According to the exemplary embodiment of the present disclosure, the gas-liquid separator may include a droplet capturing part provided in the housing member and configured to capture the droplets separated from the air.

The droplet capturing part may have various structures capable of capturing droplets separated from the air by the vortex.

According to the exemplary embodiment of the present disclosure, the droplet capturing part may be provided at an end of the housing member based on a longitudinal direction of the housing member and communicate with the inside of the housing member.

According to the exemplary embodiment of the present disclosure, the housing member may have a first cross-sectional area, and the droplet capturing part may have a second cross-sectional area larger than the first cross-sectional area by at least 10% or more.

Because the droplet capturing part has a larger cross-sectional area than the housing member as described above, the droplets separated from the air (the droplets captured by the inner peripheral surface of the housing member) may move along the inner peripheral surface of the housing member and be captured in the capturing space of the droplet capturing part, and only the air, from which the droplets are separated, may be introduced into the variable pressure flow path.

According to the exemplary embodiment of the present disclosure, the gas-liquid separator may include a droplet guide part protruding from the droplet capturing part while facing the inlet of the variable pressure flow path.

The droplet guide part may have various sizes in accordance with required conditions and design specifications.

According to the exemplary embodiment of the present disclosure, the droplet guide part may have a larger diameter than the inlet of the variable pressure flow path. In a plan view, the droplet guide part may be disposed to cover the entire inlet of the variable pressure flow path.

Because the droplet guide part has a larger diameter than the inlet of the variable pressure flow path as described above, the droplets departing from the capturing space may be introduced into a space between the outer surface of the vortex generation member and the inner surface of the housing member without being immediately introduced into the inlet of the variable pressure flow path. Therefore, it is possible to obtain an advantageous effect of minimizing a degree to which the droplets are introduced into the variable pressure flow path.

According to an exemplary embodiment of the present disclosure, the droplet capturing part may have a first length in the longitudinal direction of the housing member, and the droplet guide part may have a second length equal to or longer than the first length.

As described above, the droplet guide part has a length equal to or longer than the length of the droplet capturing part, such that it is possible to obtain an advantageous effect of minimizing a degree to which the droplets depart from the capturing space.

According to the exemplary embodiment of the present disclosure, the gas-liquid separator may include an expansion guide part provided at the other end of the vortex generation member and having a larger cross-sectional area than the inlet of the variable pressure flow path.

The expansion guide part may have various structures having a larger cross-sectional area than the inlet of the variable pressure flow path.

According to the exemplary embodiment of the present disclosure, the expansion guide part may be provided to have a cross-sectional area that gradually increases from one end, which is adjacent to the discharge port, toward the other end.

According to the exemplary embodiment of the present disclosure, a main wall portion of the expansion guide part may be provided to be inclined at a second reference angle preset with respect to the first reference line that passes through the center of the vortex generation member in the longitudinal direction of the housing member.

As described above, in an embodiment of the present disclosure, the second reference angle with respect to the first reference line is defined to be larger than 0 degrees and equal to or smaller than 60 degrees. Therefore, it is possible to obtain an advantageous effect of ensuring the performance in changing pressure (performance in reducing differential pressure) by means of the variable pressure flow path and sufficiently ensuring the efficiency in separating air and droplets.

### BRIEF DESCRIPTION OF THE DRAWINGS

FIG. 1 is a view illustrating a gas-liquid separator according to an embodiment of the present disclosure.

FIG. 2 is a view illustrating a vortex generation member and a variable pressure flow path of the gas-liquid separator according to the embodiment of the present disclosure.

FIG. 3 is a view illustrating a movement route for air in the gas-liquid separator according to the embodiment of the present disclosure.

FIG. 4 is a view illustrating an expansion guide part of the gas-liquid separator according to the embodiment of the present disclosure.

### DETAILED DESCRIPTION

Hereinafter, exemplary embodiments of the present disclosure will be described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

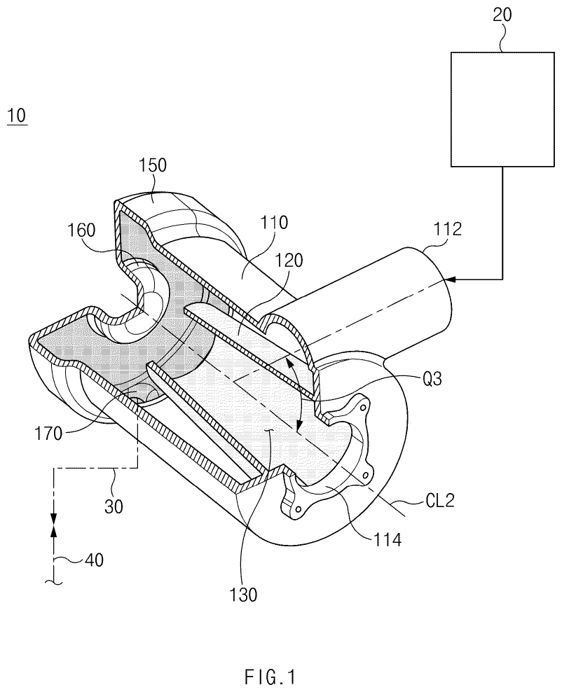

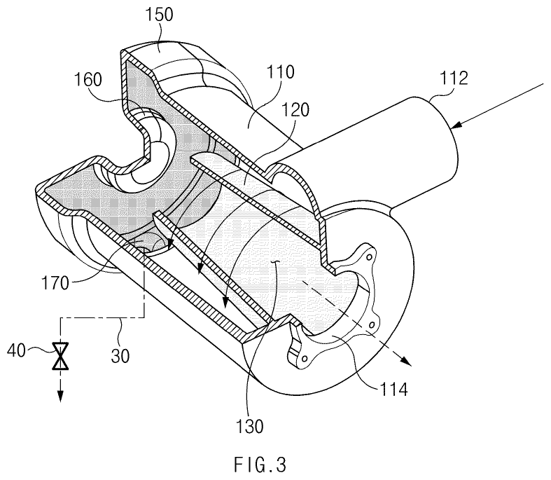

With reference to FIGS. 1 to 4, a gas-liquid separator 10 according to an embodiment of the present disclosure includes a housing member 110 having an inlet port 112 through which air is introduced, and a discharge port 114 through which air is discharged, a vortex generation member 120 provided in the housing member 110 and configured to generate a vortex in the air introduced into the housing member 110 so that droplets contained in the air come into contact with an inner surface of the housing member 110, and a variable pressure flow path 130 provided in the housing member 110 and configured to guide the air, from which droplets are separated, to the discharge port 114 and change pressure of the air from an inlet toward an outlet.

For reference, the gas-liquid separator 10 according to the embodiment of the present disclosure may be used to capture droplets from air discharged from an object. The present disclosure is not restricted or limited by the type and properties of the object to which the gas-liquid separator 10 is applied.

Hereinafter, an example will be described in which the gas-liquid separator 10 according to the embodiment of the present disclosure is applied to capture droplets from air discharged from a fuel cell stack 20 applied to mobility vehicles such as automobiles, ships, and airplanes.

The fuel cell stack 20 refers to a kind of power generation device that generates electrical energy through a chemical reaction of fuel (e.g., hydrogen), and the fuel cell stack may be configured by stacking several tens or hundreds of fuel cells (unit cells) in series.

The fuel cell may have various structures capable of producing electricity by means of an oxidation-reduction reaction between fuel (e.g., hydrogen) and an oxidant (e.g., air).

For example, the fuel cell may include a membrane electrode assembly (MEA) (not illustrated) having catalyst electrode layers in which electrochemical reactions occur and which are attached to two opposite sides of an electrolyte membrane through which hydrogen ions move, a gas diffusion layer (GDL) (not illustrated) configured to uniformly distribute reactant gases and transfer generated electrical energy, a gasket (not illustrated) and a fastener (not illustrated) configured to maintain leakproof sealability for the reactant gases and a coolant and maintain an appropriate fastening pressure, and a separator (bipolar plate) (not illustrated) configured to move the reactant gases and the coolant.

More specifically, in the fuel cell, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

With reference to FIGS. 1 to 3, the housing member 110 includes the inlet port 112 through which the air discharged from the fuel cell stack 20 is introduced, and the discharge port 114 through which the air is discharged.

Hereinafter, an example will be described in which the air discharged from the fuel cell stack 20 is supplied to the inlet port 112 of the housing member 110 while passing through a humidifier (e.g., a humidifier configured to humidify air, which is to be supplied to the fuel cell stack, by using moist air discharged from the fuel cell stack) (not illustrated). According to another embodiment of the present disclosure, the air discharged from the fuel cell stack may be immediately supplied to the inlet port of the housing member without passing through the humidifier.

The housing member 110 may have various structures having the inlet port 112 and the discharge port 114. The present disclosure is not restricted or limited by the structure of the housing member 110.

For example, the housing member 110 may have an approximately hollow circular shape having a predetermined diameter. The inlet port 112 and the discharge port 114 may each have a circular cross-section.

The inlet port 112 and the discharge port 114 may be provided at various points on the housing member 110 in accordance with required conditions and design specifications.

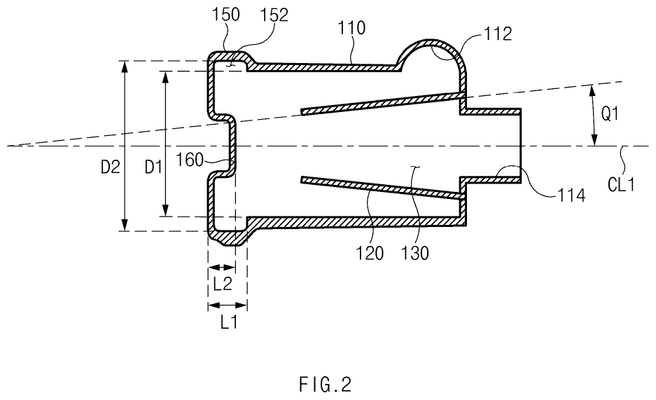

According to the exemplary embodiment of the present disclosure, the inlet port 112 may be provided at one end (a right end based on FIG. 2) of the housing member 110 based on a longitudinal direction of the housing member 110, and the inlet port 112 may be provided in a main wall portion (sidewall portion) of the housing member 110. In particular, the inlet port 112 may be provided adjacent to one end of the housing member 110 (an outlet of the vortex generation member) adjacent to the discharge port 114.

According to an exemplary embodiment of the present disclosure, a center of the inlet port 112 may be defined to be inclined at a third reference angle θ3 preset with respect to a second reference line CL2 that passes through a center of the discharge port 114 in the longitudinal direction of the housing member 110.

The third reference angle θ3 may be variously changed in accordance with required conditions and design specifications. The present disclosure is not restricted or limited by the size of the third reference angle θ3.

According to the exemplary embodiment of the present disclosure, the third reference angle θ3 may be defined to be 60 to 120 degrees.

This is based on the fact that when the third reference angle is smaller than 60 degrees or larger than 120 degrees, the efficiency in generating a vortex in the air introduced into the housing member 110 may deteriorate. In one embodiment of the present disclosure, the center of the inlet port 112 is disposed to be inclined at 60 to 120 degrees with respect to the second reference line CL2. Therefore, it is possible to obtain an advantageous effect of stably ensuring the efficiency in generating a vortex in the air in the housing member 110. In particular, the third reference angle θ3 may be defined as 90 degrees.

With reference to FIGS. 1 to 3, the vortex generation member 120 is provided in the housing member 110 to generate a vortex in the air introduced into the housing member 110 so that the droplets contained in the air come into contact with the inner surface of the housing member 110.

In this case, the configuration in which a vortex is generated in the air may be defined as a configuration in which the air introduced into the housing member 110 generates a swirling airflow.

As described above, the vortex having a swirling shape is generated in the air, which is introduced into the housing member 110, such that the droplets contained in the air may be pushed, by a difference in specific gravity and a centrifugal force made by the vortex of the air, toward an edge of the housing member 110 (an inner peripheral surface of the housing member) from a central portion of the housing member 100 in a radial direction of the housing member 110, and the droplets pushed toward the edge of the housing member 110 may be captured by being brought into contact with the inner surface of the housing member 110.

The vortex generation member 120 may have various structures capable of generating a vortex in the air introduced into the housing member 110. The present disclosure is not restricted or limited by the structure and shape of the vortex generation member 120.

According to the exemplary embodiment of the present disclosure, the vortex generation member 120 may be provided in the form of an approximately hollow straight tube, disposed in the housing member 110, and spaced apart from the inner peripheral surface of the housing member 110. For example, the vortex generation member 120 may be coaxially disposed in the housing member 110.

As described above, the vortex generation member 120 is provided at an approximately central portion of the housing member 110. Therefore, the air introduced through the inlet port 112 may generate a vortex while moving along a space between the inner peripheral surface of the housing member 110 and an outer peripheral surface of the vortex generation member 120. Further, the air, from which droplets are removed (separated), may move along the space between the inner peripheral surface of the housing member 110 and the outer peripheral surface of the vortex generation member 120 and then be introduced into the inlet of the variable pressure flow path 130.

According to the exemplary embodiment of the present disclosure, the vortex generation member 120 may be connected to the housing member 110 while defining a shape of a cantilevered beam (cantilever).

More specifically, one end of the vortex generation member 120 may be connected to the housing member 110 and communicate with the discharge port 114, and the other end of the vortex generation member 120 may be disposed as a free end spaced apart from the inner surface of the housing member 110.

With reference to FIGS. 1 to 3, the variable pressure flow path 130 is provided in the housing member 110 to guide the air, from which droplets are separated, to the discharge port 114. The variable pressure flow path 130 is configured to change the pressure of the air from the inlet toward the outlet.

In the embodiment of the present disclosure, the configuration in which the pressure of the air is changed from the inlet toward the outlet of the variable pressure flow path 130 is defined as including both a configuration in which the pressure of the air increases from the inlet toward the outlet of the variable pressure flow path 130 and a configuration in which the pressure of the air decreases from the inlet toward the outlet of the variable pressure flow path 130.

In particular, the variable pressure flow path 130 may be configured to gradually increase the pressure of the air from the inlet (the left end of the vortex generation member based on FIG. 2) toward the outlet (the right end of the vortex generation member based on FIG. 2).

The variable pressure flow path 130 may have various structures capable of gradually increasing the pressure of the air from the inlet toward the outlet. According to the exemplary embodiment of the present disclosure, the variable pressure flow path 130 may be provided to have a cross-sectional area that gradually increases from the inlet toward the outlet. For example, the variable pressure flow path 130 may have an approximately truncated conical shape (circular truncated cone shape) having a circular cross-section that gradually expands from one end (inlet) toward the other end (outlet).

This is to minimize an increase in differential pressure of the gas-liquid separator 10 while miniaturizing the gas-liquid separator 10.

That is, a strong vortex needs to be generated to improve the efficiency in capturing (separating) droplets from the air. In case that the size of the gas-liquid separator 10 decreases while the intensity of the vortex is maintained (increased), there occurs a problem in that differential pressure of the gas-liquid separator 10 is inevitably increased, and energy efficiency deteriorates (electric power consumption increases).

In contrast, in the embodiment of the present disclosure, the variable pressure flow path 130 has a cross-sectional area that gradually increases from the inlet toward the outlet, such that the pressure of the air discharged through the discharge port 114 (the air in the outlet of the variable pressure flow path) may be increased. Therefore, it is possible to obtain an advantageous effect of minimizing an increase in differential pressure of the gas-liquid separator 10.

According to the exemplary embodiment of the present disclosure, the variable pressure flow path 130 may be defined along the inside of the vortex generation member 120.

The configuration in which the variable pressure flow path 130 is defined along the inside of the vortex generation member 120 may be understood as a configuration in which the variable pressure flow path 130 is defined along an internal space of the vortex generation member 120.

As described above, in the embodiment of the present disclosure, the variable pressure flow path 130 is defined along the inside of the vortex generation member 120, such that the variable pressure flow path 130 for minimizing an increase in differential pressure by applying a centrifugal force to the air (applying a centrifugal force for generating a vortex) may be defined by means of the single vortex generation member 120 without separately providing a structure for generating a vortex in the air and a structure for defining the variable pressure flow path 130. Therefore, it is possible to obtain an advantageous effect of further miniaturizing the gas-liquid separator 10 and improving the spatial utilization and the degree of design freedom.

In the embodiment of the present disclosure illustrated and described above, the example has been described in which the variable pressure flow path 130 is defined in the vortex generation member 120. However, according to another embodiment of the present disclosure, the variable pressure flow path may be provided separately from the vortex generation member. For example, the variable pressure flow path may be provided along an inner surface of the housing member.

According to the exemplary embodiment of the present disclosure, a main wall portion of the vortex generation member 120 (a wall portion configured to define an inner peripheral surface of the vortex generation member), which defines the variable pressure flow path 130, may be provided to be inclined at a first reference angle θ1 preset with respect to a first reference line CL1 that passes through a center of the vortex generation member 120 in the longitudinal direction of the housing member 110.

The first reference angle θ1 may be variously changed in accordance with required conditions and design specifications. The present disclosure is not restricted or limited by the size of the first reference angle θ1.

According to the exemplary embodiment of the present disclosure, the first reference angle θ1 may be defined to be larger than 0 degrees and equal to or smaller than 30 degrees.

This is based on the fact that when the first reference angle is larger than 30 degrees, it is difficult to ensure performance in changing pressure (performance in reducing differential pressure) by means of the variable pressure flow path 130 and ensure a sufficient discharge flow rate of the air. In the embodiment of the present disclosure, the first reference angle θ1 with respect to the first reference line CL1 is defined to be larger than 0 degrees and equal to or smaller than 30 degrees. Therefore, it is possible to obtain an advantageous effect of ensuring the performance in changing pressure (performance in reducing differential pressure) by means of the variable pressure flow path 130 and ensuring a sufficient discharge flow rate of the air.

According to the exemplary embodiment of the present disclosure, the gas-liquid separator 10 may include a droplet capturing part 150 provided in the housing member 110 and configured to capture droplets separated from the air.

The droplet capturing part 150 may have various structures capable of capturing droplets separated from the air by the vortex. The present disclosure is not restricted or limited by the structure and shape of the droplet capturing part 150.

According to the exemplary embodiment of the present disclosure, the droplet capturing part 150 may be provided integrally with the housing member 110 and define a capturing space 152 at an end (the left end based on FIG. 2) of the housing member 110 based on the longitudinal direction of the housing member 110 so that the capturing space 152 communicates with the inside of the housing member 110.

The capturing space 152 of the droplet capturing part 150 may be defined to have various sizes to define a stepped portion together with the inner peripheral surface of the housing member 110.

According to the exemplary embodiment of the present disclosure, the housing member 110 may have a first cross-sectional area, and the droplet capturing part 150 may have a second cross-sectional area larger than the first cross-sectional area by at least 10% or more. For example, the housing member 110 may have a first diameter D1, and the droplet capturing part 150 may have a second diameter D2 that is 1.1 times the first diameter D1.

With the above-mentioned structure, the droplets separated from the air (the droplets captured by the inner peripheral surface of the housing member) may move along the inner peripheral surface of the housing member 110 and be captured in the capturing space 152 of the droplet capturing part 150, and only the air, from which the droplets are separated, may be introduced into the variable pressure flow path 130.

According to the exemplary embodiment of the present disclosure, the gas-liquid separator 10 may include a droplet guide part 160 protruding from the droplet capturing part 150 while facing the inlet of the variable pressure flow path 130.

The droplet guide part 160 is configured to minimize a degree to which the droplets captured in the capturing space 152 depart from the capturing space 152.

The droplet guide part 160 may have various structures in accordance with required conditions and design specifications. The present disclosure is not restricted or limited by the structure and shape of the droplet guide part 160.

For example, the droplet guide part 160 may protrude from an approximately central portion of the droplet capturing part 150 while having a circular protrusion shape having a circular cross-section. The droplets captured in the capturing space 152 may rotate about the droplet guide part 160 in a circumferential direction of the capturing space 152.

The droplet guide part 160 may have various sizes in accordance with required conditions and design specifications. The present disclosure is not restricted or limited by the size of the droplet guide part 160.

According to the exemplary embodiment of the present disclosure, the droplet guide part 160 may have a larger diameter than the inlet of the variable pressure flow path 130. In a plan view, the droplet guide part 160 may be disposed to cover the entire inlet of the variable pressure flow path 130.

Because the droplet guide part 160 has a larger diameter than the inlet of the variable pressure flow path 130 as described above, the droplets departing from the capturing space 152 may be introduced into a space between the outer surface of the vortex generation member 120 and the inner surface of the housing member 110 without being immediately introduced into the inlet of the variable pressure flow path 130. Therefore, it is possible to obtain an advantageous effect of minimizing a degree to which the droplets are introduced into the variable pressure flow path 130.

According to the exemplary embodiment of the present disclosure, the droplet capturing part 150 may have a first length in the longitudinal direction of the housing member 110, and the droplet guide part 160 may have a second length equal to or longer than the first length.

This is based on the fact that when the droplet guide part 160 has a shorter length than the droplet capturing part 150, the droplets captured in the capturing space 152 easily depart from the capturing space 152. In the embodiment of the present disclosure, the droplet guide part 160 has a length (second length) equal to or longer than the length of the droplet capturing part 150, such that it is possible to obtain an advantageous effect of minimizing a degree to which the droplets depart from the capturing space.

According to an exemplary embodiment of the present disclosure, the gas-liquid separator 10 may include a droplet discharge port 170 provided in the droplet capturing part 150 and configured to communicate with the capturing space 152 and discharge the droplets, which are captured in the capturing space 152, to the outside of the droplet capturing part 150.

In addition, a discharge line 30 may be connected to the droplet discharge port 170. The droplets captured in the capturing space 152 may be discharged along the discharge line 30 via the droplet discharge port 170.

In addition, an opening/closing valve 40 may be provided in the discharge line 30 and may selectively open or close the discharge line 30.

In this case, the configuration in which the discharge line 30 is selectively opened or closed may be understood as including both a process of turning on or off a flow of droplets to be discharged along the discharge line 30 and a process of controlling a flow rate of droplets.

A typical valve capable of opening or closing the discharge line 30 may be used as the opening/closing valve 40. The present disclosure is not restricted or limited by the type and structure of the opening/closing valve 40. For example, a typical solenoid valve may be used as the opening/closing valve 40.

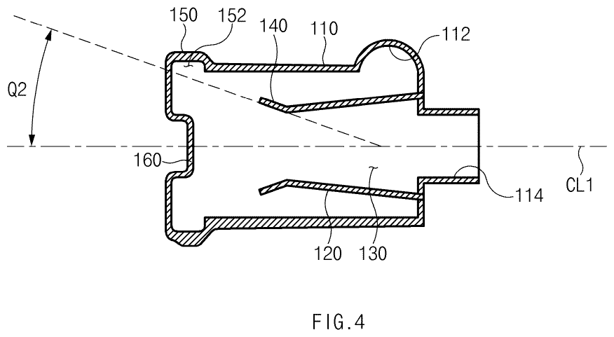

With reference to FIG. 4, according to the exemplary embodiment of the present disclosure, the gas-liquid separator 10 may include an expansion guide part 140 provided at the other end (the left end based on FIG. 4) of the vortex generation member 120 and having a larger cross-sectional area than the inlet of the variable pressure flow path 130.

The expansion guide part 140 is configured to improve the efficiency in separating droplets and air while minimizing an increase in differential pressure of the gas-liquid separator 10.

The expansion guide part 140 may have various structures having a larger cross-sectional area than the inlet of the variable pressure flow path 130. The present disclosure is not restricted or limited by the structure and shape of the expansion guide part 140.

According to an exemplary embodiment of the present disclosure, the expansion guide part 140 may have a cross-sectional area that gradually increases from one end (the right end based on FIG. 4), which is adjacent to the discharge port 114, toward the other end (the left end based on FIG. 4). For example, the expansion guide part 140 may have a circular cross-section that gradually expands from one end, which is adjacent to the discharge port 114, toward the other end. Alternatively, the expansion guide part 140 may have a quadrangular cross-section or other cross-sectional shapes.

According to the exemplary embodiment of the present disclosure, a main wall portion of the expansion guide part 140 may be provided to be inclined at a second reference angle θ2 preset with respect to the first reference line CL1 that passes through the center of the vortex generation member 120 in the longitudinal direction of the housing member 110.

The second reference angle θ2 may be variously changed in accordance with required conditions and design specifications. The present disclosure is not restricted or limited by the size of the second reference angle θ2.

According to the exemplary embodiment of the present disclosure, the second reference angle θ2 may be defined to be larger than 0 degrees and equal to or smaller than 60 degrees.

This is based on the fact that when the second reference angle θ2 is larger than 60 degrees, it is difficult to ensure performance in changing pressure (performance in reducing differential pressure) by means of the variable pressure flow path 130 and sufficiently ensure the efficiency in separating air and droplets. In the embodiment of the present disclosure, the second reference angle θ2 with respect to the first reference line CL1 is defined to be larger than 0 degrees and equal to or smaller than 60 degrees. Therefore, it is possible to obtain an advantageous effect of ensuring the performance in changing pressure (performance in reducing differential pressure) by means of the variable pressure flow path 130 and sufficiently ensuring the efficiency in separating air and droplets.

According to the embodiment of the present disclosure described above, it is possible to obtain an advantageous effect of minimizing an increase in differential pressure while ensuring the performance in capturing droplets contained in the air discharged from the fuel cell stack.

In particular, according to the embodiment of the present disclosure, it is possible to obtain an advantageous effect of minimizing a deterioration in energy efficiency caused by an increase in differential pressure of the gas-liquid separator while miniaturizing the gas-liquid separator.

Among other things, according to an embodiment of the present disclosure, the pressure of the air is changed as the air, from which droplets are separated by the vortex, moves along the variable pressure flow path. Therefore, it is possible to obtain an advantageous effect of minimizing an increase in differential pressure while miniaturizing the gas-liquid separator.

Moreover, according to an embodiment of the present disclosure, the variable pressure flow path for minimizing an increase in differential pressure by applying a centrifugal force to the air (applying a centrifugal force for generating a vortex) may be defined by means of the single vortex generation member without separately providing a structure for generating a vortex in the air and a structure for defining the variable pressure flow path. Therefore, it is possible to obtain an advantageous effect of further miniaturizing the gas-liquid separator.

In addition, according to an embodiment of the present disclosure, it is possible to obtain an advantageous effect of simplifying the structure and improving the degree of design freedom and spatial utilization.

In addition, according to an embodiment of the present disclosure, it is possible to obtain an advantageous effect of minimizing a situation in which the droplets and the air are mixed again and improving the efficiency in separating the droplets.

While the embodiments have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A gas-liquid separator comprising:
a housing member having an inlet port through which air is introduced, and a discharge port through which the air is discharged;
a vortex generation member provided in the housing member and configured to generate a vortex in the air introduced into the housing member so that droplets contained in the air come into contact with an inner surface of the housing member; and
a variable pressure flow path provided in the housing member and configured to guide the air, from which the droplets are separated, to the discharge port and change pressure of the air from an inlet toward an outlet thereof.

2. The gas-liquid separator of claim 1, wherein the variable pressure flow path is configured to gradually increase the pressure of the air from the inlet toward the outlet thereof.

3. The gas-liquid separator of claim 2, wherein the variable pressure flow path is provided to have a cross-sectional area that gradually increases from the inlet toward the outlet thereof.

4. The gas-liquid separator of claim 1, wherein the vortex generation member is provided to be spaced apart from an inner peripheral surface of the housing member, and the variable pressure flow path is defined along the inside of the vortex generation member.

5. The gas-liquid separator of claim 4, wherein one end of the vortex generation member is connected to the housing member and communicates with the discharge port, and the other end of the vortex generation member is disposed as a free end spaced apart from the inner surface of the housing member.

6. The gas-liquid separator of claim 5, wherein a main wall portion of the vortex generation member is provided to be inclined at a first reference angle preset with respect to a first reference line that passes through a center of the vortex generation member in a longitudinal direction of the housing member.

7. The gas-liquid separator of claim 6, wherein the first reference angle is defined to be larger than 0 degrees and equal to or smaller than 30 degrees.

8. The gas-liquid separator of claim 5, comprising:
an expansion guide part provided at the other end of the vortex generation member and having a larger cross-sectional area than the inlet of the variable pressure flow path.

9. The gas-liquid separator of claim 8, wherein the expansion guide part is provided to have a cross-sectional area that gradually increases from one end, which is adjacent to the discharge port, toward the other end in a longitudinal direction of the housing member.

10. The gas-liquid separator of claim 8, wherein a main wall portion of the expansion guide part is provided to be inclined at a second reference angle preset with respect to a first reference line that passes through a center of the vortex generation member in a longitudinal direction of the housing member.

11. The gas-liquid separator of claim 10, wherein the second reference angle is defined to be larger than 0 degrees and equal to or smaller than 60 degrees.

12. The gas-liquid separator of claim 1, wherein the discharge port is provided at one end of the housing member based on a longitudinal direction of the housing member, and the inlet port is provided in a main wall portion of the housing member.

13. The gas-liquid separator of claim 12, wherein a center of the inlet port is defined to be inclined at a third reference angle preset with respect to a second reference line that passes through a center of the discharge port in the longitudinal direction of the housing member.

14. The gas-liquid separator of claim 13, wherein the third reference angle is defined to be 60 to 120 degrees.

15. The gas-liquid separator of claim 1, comprising:
a droplet capturing part provided in the housing member and configured to capture the droplets separated from the air.

16. The gas-liquid separator of claim 15, wherein the droplet capturing part is provided at an end of the housing member based on a longitudinal direction of the housing member and communicates with the inside of the housing member.

17. The gas-liquid separator of claim 16, wherein the housing member is provided to have a first cross-sectional area, and the droplet capturing part is provided to have a second cross-sectional area larger than the first cross-sectional area by at least 10% or more.

18. The gas-liquid separator of claim 15, comprising:
a droplet guide part protruding from the droplet capturing part while facing the inlet of the variable pressure flow path.

19. The gas-liquid separator of claim 18, wherein the droplet guide part is provided to have a larger diameter than the inlet of the variable pressure flow path.

20. The gas-liquid separator of claim 19, wherein the droplet capturing part is provided to have a first length in a longitudinal direction of the housing member, and the droplet guide part is provided to have a second length equal to or longer than the first length.
